(19) United States
(12) Patent Application Publication
(10) Pub. No.: US 2024/0286540 A1
(43) Pub. Date: Aug. 29, 2024

(54) EFFECTIVE COMPONENT GENERATION DEVICE

(71) Applicant: Panasonic Automotive Systems Co., Ltd., Kanagawa (JP)

(72) Inventors: Takeshi MIYAOKA, Osaka (JP); Masahiro JIGI, Fukui (JP); Hideyuki MURAKAMI, Kanagawa (JP)

(21) Appl. No.: 18/656,232

(22) Filed: May 6, 2024

Related U.S. Application Data
(63) Continuation of application No. PCT/JP2022/039438, filed on Oct. 24, 2022.

(30) Foreign Application Priority Data
Nov. 30, 2021 (JP) 2021-194691

(51) Int. Cl. B60N 3/00; B60H 1/00

(52) U.S. Cl. CPC B60N 3/001; B60H 1/00828

(57) ABSTRACT

An effective component generation device includes an effective component generator and a controller. The effective component generator generates an effective component inside a table storage provided to an armrest in a vehicle. The table storage can store a table. The effective component generator is provided in the table storage. The effective component generation device includes a fan. The controller drives the fan when the controller causes the effective component generator to generate the effective component. The effective component generation device includes a direction switcher. The controller controls the direction switcher to control a direction in which the effective component flows. When the table is stored in the table storage, the controller controls the direction switcher to cause the effective component to flow into the table storage.

### CROSS REFERENCE TO RELATED APPLICATIONS

This is a continuation application of PCT International Application No. PCT/JP2022/039438 filed on Oct. 24, 2022, designating the United States of America, which is based on and claims priority of Japanese Patent Application No. 2021-194691 filed on Nov. 30, 2021.

### FIELD

The present disclosure relates to an effective component generation device that generates an effective component.

### BACKGROUND

Air cleaners for cleaning air have been known. As an example of air cleaners of the type, PTL 1 discloses an air cleaner for vehicle that purifies air in a cabin regardless of whether an armrest at a seat is in use or stored.

### CITATION LIST

### Patent Literature

PTL 1: Japanese Unexamined Patent Application Publication No. 2004-352160

### SUMMARY

However, the device according to Patent Literature (PTL) 1 can be improved upon. In view of this, the present disclosure provides an effective component generation device capable of improving upon the above related art.

In accordance with an aspect of the present disclosure, an effective component generation device includes: an effective component generator that generates an effective component; and a controller that controls the effective component generator, wherein the effective component generator generates the effective component toward inside of a table storage provided to an armrest in a vehicle, the table storage is configured to store a table to be touched with a human hand, the effective component generator is provided within the table storage, the effective component generation device further comprises a fan driven and controlled by the controller, the controller drives the fan when the controller causes the effective component generator to generate the effective component, the effective component generation device further comprises a direction switcher that selectively changes a direction in which the effective component flows, the controller controls the direction switcher to control the direction in which the effective component flows, and when the table is stored in the table storage, the controller controls the direction switcher to cause the effective component to flow into the table storage.

In accordance with another aspect of the present disclosure, an effective component generation device includes: an effective component generator that generates an effective component; and a controller that controls the effective component generator, wherein the effective component generator generates the effective component toward inside of a table storage provided to an armrest in a vehicle, the table storage is configured to store a table to be touched with a human hand, the effective component generator is provided within the table storage, the effective component generation device further comprises a fan driven and controlled by the controller, the controller drives the fan when the controller causes the effective component generator to generate the effective component, the effective component generation device further comprises a direction switcher that selectively changes a direction in which the effective component flows, the controller controls the direction switcher to control the direction in which the effective component flows, and when the table is not stored in the table storage, the controller controls the direction switcher to cause the effective component to flow inside a cabin of the vehicle.

In accordance with still another aspect of the present disclosure, an effective component generation device includes: an effective component generator that generates an effective component; and a controller that controls the effective component generator, wherein the effective component generator generates the effective component toward inside of a table storage provided to an armrest in a vehicle, the table storage is configured to store a table to be touched with a human hand, the effective component generator is provided within the table storage, the effective component generation device further comprises a first detector that detects whether or not the table is stored in the table storage, the controller controls the effective component generator based on the detection performed by the first detector, and when the first detector detects that the table is not stored in the table storage, the controller causes the effective component generator to generate the effective component to fill the inside of the table storage with the effective component.

General or specific aspects of the present disclosure may be implemented to a system, a method, an integrated circuit, a computer program, a computer-readable recording medium such as a Compact Disc-Read Only Memory (CD-ROM), or any given combination thereof. The recording medium may be a non-transitory recording medium.

The effective component generation device according to an aspect of the present disclosure is capable of improving upon the above related art. Chances of the table coming into contact with the effective component can be increased.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a sight inside a vehicle when a table is stored in a table storage.

FIG. 2 is a diagram illustrating a sight inside the vehicle when the table is pulled out of the table storage.

FIG. 3 is a diagram illustrating simplified actions of the table and the table storage.

FIG. 4 is a diagram schematically illustrating an effective component generation device according to an embodiment.

FIG. 5 is a block diagram of the effective component generation device according to the embodiment.

FIG. 6 is a diagram illustrating a flow of an effective component when a table is stored in a table storage.

FIG. 7 is a diagram illustrating a flow of the effective component when the table is not stored in the table storage.

FIG. 8 is a diagram illustrating a flow of the effective component when an object is close to an armrest.

FIG. 9 is a flowchart illustrating operation of the effective component generation device according to the embodiment.

FIG. 10 is a flowchart illustrating another example of operation of the effective component generation device according to the embodiment.

### DESCRIPTION OF EMBODIMENT

For example, although a table storage that stores a table may in some cases be provided to an armrest at a seat, there has been no disclosure in the related art to increase chances of the table coming into contact with an effective component.

Accordingly, the present disclosure provides an effective component generation device capable of increasing chances of the table coming into contact with the effective component.

### SUMMARY OF THE PRESENT DISCLOSURE

An effective component generation device according to an aspect of the present disclosure includes: an effective component generator that generates an effective component; and a controller that controls the effective component generator, wherein the effective component generator generates the effective component toward inside of a table storage provided to an armrest in a vehicle.

According to the configuration, for example, when the table is stored in the table storage, chances of the table coming into contact with the effective component can be increased. In this way, the table can be made hygienic by using the effective component.

It is possible that the table storage is configured to store a table to be touched with a human hand, and that the effective component generator is provided within the table storage.

According to the configuration, for example, when the table is stored in the table storage, chances of the table coming into contact with the effective component can be increased. In this way, the table can be made hygienic by using the effective component generator in the table storage.

It is possible that the effective component generation device further includes: a first detector that detects whether or not the table is stored in the table storage, wherein the controller controls the effective component generator based on the detection performed by the first detector.

According to the configuration, based on the detection performed by the first detector, chances of the table coming into contact with the effective component can be increased by using the effective component generator.

It is possible that, when the first detector detects that the table is stored in the table storage, the controller causes the effective component generator to generate the effective component.

According to the configuration, on condition that the table is assuredly stored as detected by the first detector, chances of the table coming into contact with the effective component can be increased.

It is possible that the effective component generation device further includes a fan driven and controlled by the controller, and that the controller drives the fan when the controller causes the effective component generator to generate the effective component.

According to the configuration, the effective component generated by the effective component generator can be moved by the wind from the fan. Accordingly, chances of a subject such as a table coming into contact with the effective component can be increased.

It is possible that the effective component generation device further includes a direction switcher that selectively changes a direction in which the effective component flows, and that the controller controls the direction switcher to control the direction in which the effective component flows.

According to the configuration, the direction in which the effective component flows can be selectively changed by using the direction switcher. Accordingly, chances of not only the table but also, for example, other objects than the table or a person coming into contact with the effective component can be increased.

It is possible that, when the table is stored in the table storage, the controller controls the direction switcher to cause the effective component to flow into the table storage.

According to the configuration, chances of the table coming into contact with the effective component can be increased.

It is possible that the effective component generation device further includes a second detector that detects an object approaching the armrest, wherein when the second detector detects the object, the controller controls the direction switcher to cause the effective component to flow toward the object for a first time period.

According to the configuration, chances of not only the table but also objects that are close to the armrest coming into contact with the effective component can be increased.

It is possible that the controller drives the fan to cause an air volume of the fan to be greater when the effective component is made to flow toward the object than when the effective component is made to flow into the table storage.

According to the configuration, chances of objects that are close to the armrest coming into contact with the effective component can be increased.

It is possible that, after the first time period, the controller controls the direction switcher to prevent the effective component from flowing toward the object and cause the effective component to flow into the table storage.

According to the configuration, after chances of objects that are close to the armrest coming into contact with the effective component are increased, chances of the table coming into contact with the effective component can be increased.

It is possible that, when the table is not stored in the table storage, the controller controls the direction switcher to cause the effective component to flow inside a cabin of the vehicle.

According to the configuration, when the table is not stored in the table storage, the effective component can be caused to flow inside the cabin.

It is possible that the effective component generation device further includes: a second detector that detects an object approaching the armrest, wherein when the second detector detects the object, the controller controls the direction switcher to cause the effective component to flow toward the object for a first time period.

According to the configuration, chances of objects that are close to the armrest coming into contact with the effective component can be increased.

It is possible that the controller drives the fan to cause an air volume of the fan to be greater when the effective component is made to flow toward the object than when the effective component is made to flow inside a cabin of the vehicle.

According to the configuration, chances of objects that are close to the armrest coming into contact with the effective component can be increased.

It is possible that, after the first time period, the controller controls the direction switcher to prevent the effective component from flowing toward the object and cause the effective component to flow inside a cabin of the vehicle.

According to the configuration, after chances of objects that are close to the armrest coming into contact with the effective component are increased, the effective component can be caused to flow inside the cabin.

It is possible that, when the first detector detects that the table is not stored in the table storage, the controller causes the effective component generator to generate the effective component to fill the inside of the table storage with the effective component.

According to this, when a transition is made from a state in which the table is not stored in the table storage to a state in which the table is stored in the table storage, chances of the table coming into contact with the effective component in a short time can be increased.

It is possible that the controller causes the effective component generator to generate the effective component for a second time period from turning-off of an ignition of the vehicle.

According to this, after the ignition is turned off, chances of the table coming into contact with the effective component can be increased.

It is possible that the table to be stored in the table storage includes an input interface for operating a device provided to the vehicle.

According to this, chances of the table including the input interface coming into contact with the effective component can be increased.

Hereinafter, a certain exemplary embodiment will be described in detail with reference to the accompanying Drawings. The following embodiment is a specific example of the present disclosure. The numerical values, shapes, materials, elements, and arrangement and connection configuration of the elements, etc., described in the following embodiment are merely examples, and are not intended to limit the present disclosure. Among elements in the following embodiment, those not described in any one of the independent claims indicating the broadest concept of the present disclosure are described as optional elements.

Note that the respective figures are schematic diagrams and are not necessarily precise illustrations. Additionally, components that are essentially the same share like reference signs in the figures. Accordingly, overlapping explanations thereof are omitted or simplified.

In each figure, an axis along a front-back direction of the vehicle is designated as an X-axis, an axis along a width direction of the vehicle is designated as a Y-axis, and an axis along the vertical direction is designated as a Z-axis. The vehicle is, for example, an automobile, but is not a limitation and may be any movable body such as an electric railcar and the Shinkan-sen bullet train.

### EMBODIMENT

### [Configuration of Effective Component Generation Device]

The effective component generation device according to the embodiment is a device that generates an effective component such that chances of a subject such as a table coming into contact with the effective component can be increased. The effective component generation device can increase chances of a subject such as a table coming into contact with the effective component by carrying out at least one of, for example, generating the effective component toward inside of the table storage, causing the effective component to flow toward an object (for example, a hand) when the object approaching the armrest is detected, and causing the effective component to flow inside the cabin of the vehicle when the table is not stored in the table storage.

Before the configuration of the effective component generation device is described, the configuration of the table, the table storage that stores the table, and the like will be described.

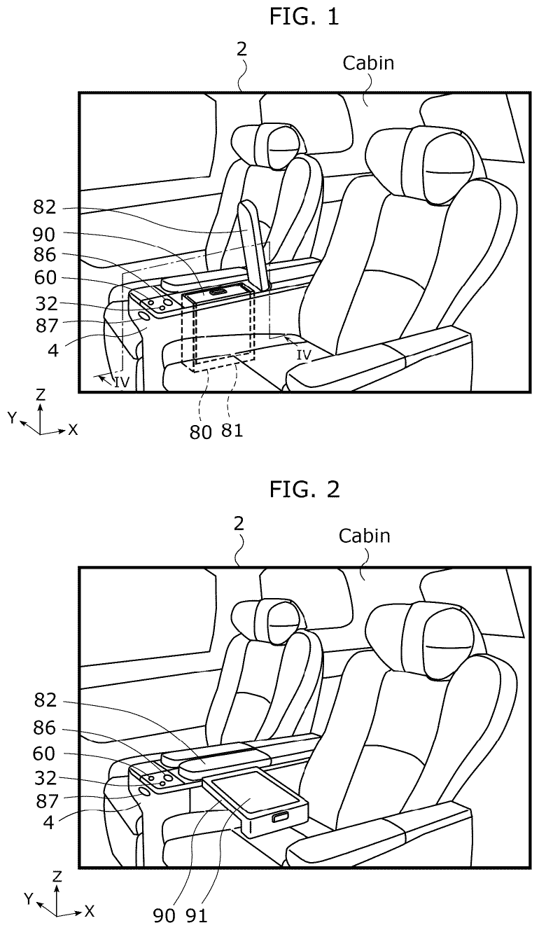

FIG. 1 is a diagram illustrating a sight inside vehicle 2 when table 90 is stored in table storage 80. FIG. 2 is a diagram illustrating a sight inside vehicle 2 when table 90 is pulled out of table storage 80.

Table storage 80 includes box-shaped case 81 for storing table 90 and lid 82. An opening is provided on top of case 81, and lid 82 is provided over the opening. An escape hole for suitable ventilation or an air intake may be provided between case 81 and lid 82. Table storage 80 allows table 90 to be stored by using lid 82 to open and close the opening. For example, table storage 80 is provided to armrest 4 next to a seat in vehicle 2.

Armrest 4 is provided with actuation switch 60 for actuating the effective component generation device and a sensor (second detector 32 described later) that detects whether or not an object (for example, a hand of a person in the seat) is close to armrest 4. Furthermore, to discharge the effective component in the cabin, armrest 4 is provided with outlet 86 that discharges the effective component in the vertical direction and outlet 87 that discharges the effective component in the horizontal direction. Outlets 86 and 87 each include a blade, so that the blowout direction can be changed, or the outlet can be closed.

For example, table 90 is a user interface that accepts an operational input from a user who uses an electrical device. Table 90 includes, for example, input interface 91 for operating electrical devices such as an illumination device, an air conditioning device, a seat heater, a video device, or an audio device in the cabin. For example, input interface 91 includes a capacitive touch sensor that accepts a touch input on a carrying surface of the table, and a transmission controller that transmits information to electrical devices or the like when the touch input is accepted by the touch sensor, the information indicating an instruction in accordance with detected results by the touch sensor. For example, table 90 is put in and taken out from table storage 80 manually. Not limited to manual, table 90 may be put in and taken out from table storage 80 automatically by a device provided to vehicle 2. Table 90 is not limited to a table for the operational input, and may be a dining table or a working table.

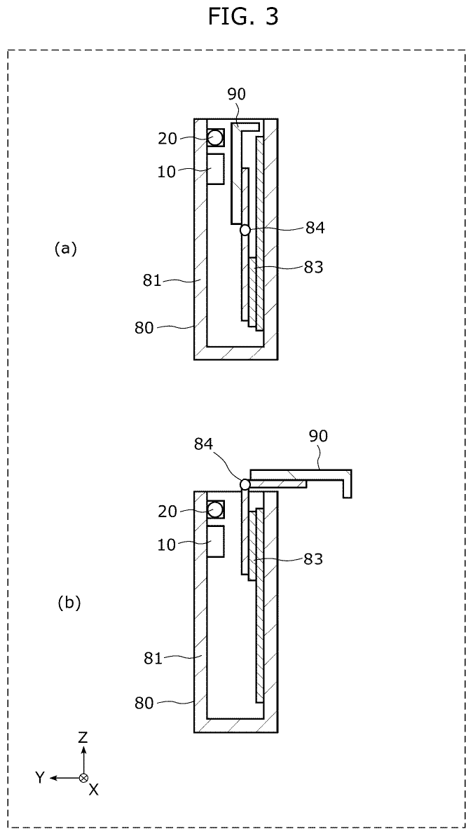

FIG. 3 is a diagram illustrating simplified actions of table 90 and table storage 80. FIG. 3 is a diagram illustrating sections when table 90 and table storage 80 are viewed from the front of vehicle 2. In the figure, lid 82 is not illustrated.

Table storage 80 includes sliding mechanism 83 and rotating mechanism 84 (see (a) of FIG. 3). Sliding mechanism 83 is attached to an inner side surface of case 81 of table storage 80. Sliding mechanism 83 is a mechanism that allows rotating mechanism 84 and table 90 attached to rotating mechanism 84 to move in the vertical direction. Rotating mechanism 84 is a mechanism that allows table 90 to rotationally move around a horizontal axis along the front-back direction of vehicle 2 (see (b) of FIG. 3). Table 90 is put in and taken out from table storage 80 via sliding mechanism 83 and rotating mechanism 84.

Table 90 accepts an operational input such as a touch input and transmits a signal in accordance with the operational input to an electrical device or an ECU (Electronic Control Unit), which is caused to perform processing in accordance with the operational input. The operational input on table 90 is made through, for example, a touch input and the like. Accordingly, it may be desirable to increase chances of the table coming into contact with the effective component to make the table hygienic by using the effective component.

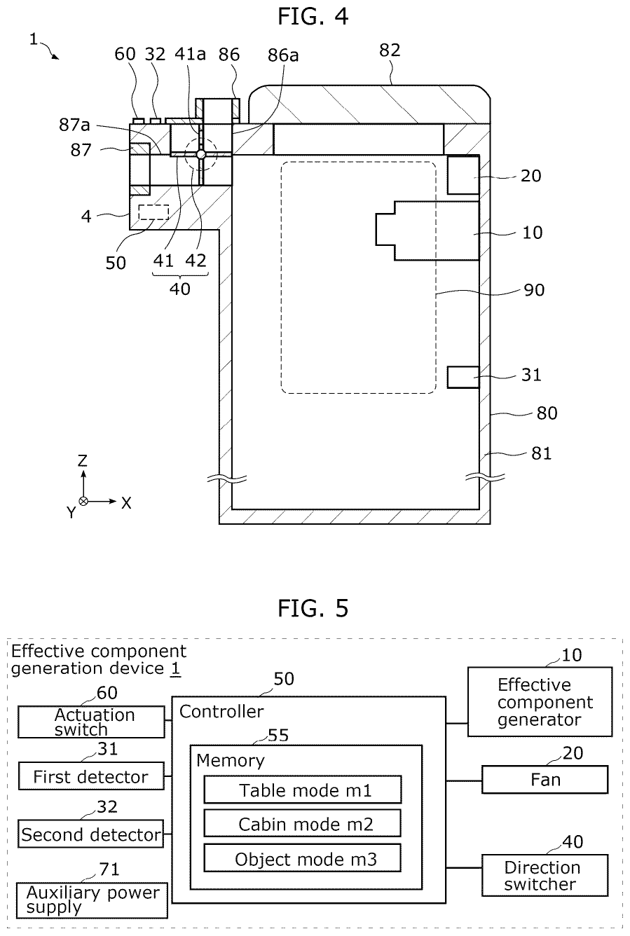

FIG. 4 is a diagram schematically illustrating effective component generation device 1 according to the embodiment.

FIG. 5 is a block diagram of effective component generation device 1. FIG. 4 is a diagram illustrating a schematic sectional view when effective component generation device 1 is viewed along a line IV-IV indicated in FIG. 1. FIG. 4 is a diagram illustrating a state of lid 82 being closed.

As illustrated in FIGS. 4 and 5, effective component generation device 1 includes effective component generator 10, fan 20, first detector 31 and second detector 32, direction switcher 40, and controller 50. As illustrated in FIG. 5, effective component generation device 1 may include actuation switch 60 and auxiliary power supply 71.

For example, effective component generation device 1 is actuated by electric power supplied from a main power supply of vehicle 2 when the ignition of vehicle 2 is on, and actuated by electric power supplied from auxiliary power supply 71 when the ignition is off.

Actuation switch 60 is a switch for switching between on and off of an actuated state of effective component generation device 1. Actuation switch 60 is provided on the top surface of armrest 4, which is not a limitation however and actuation switch 60 may be provided on a side surface of armrest 4 or the same side as outlet 87. Furthermore, actuation switch 60 may be provided on table 90, or may be provided on another operation panel different from table 90. With actuation switch 60 being turned on, effective component generation device 1 including effective component generator 10 is brought into an actuated state.

Effective component generator 10 generates the effective component. As an example, the “effective component” of the present disclosure refers to charged particulate liquid containing OH radicals, OH radicals, O₂ radicals, negative ions, positive ions, ozone, nitrate ions, or the like. These effective components form the basis for producing beneficial effects in various scenes, in addition to sanitization, deodorization, moisturizing, preservation of freshness, or viral inactivation.

Effective component generator 10 is provided inside table storage 80 and generates an effective component in table storage 80. For example, effective component generator 10 is fixed on the inner side surface of case 81 of table storage 80 and generates an effective component in a diffused manner around the horizontal axis along the front-back direction of vehicle 2.

Fan 20 is disposed immediately above, immediately below, or immediately next to effective component generator 10, and fixed on the inner side surface of case 81. For example, fan 20 is arranged such that its height position in the vertical direction is the same as the height position of outlet 87. Fan 20 generates airflow along the horizontal direction to move the effective component generated by effective component generator 10 along with the airflow. The air volume from fan 20 during air blowing is changed based on a drive command from controller 50. The change in the air volume results in a change in the wind velocity.

Direction switcher 40 is a device that switches directions of the flow of the effective component. Direction switcher 40 includes guide plate 41 that guides the flow of the effective component released by fan 20, and guide plate driving unit 42 connected to guide plate 41. Guide plate 41 is formed from a rotary shaft along the width direction of vehicle 2, and four plates radially connected to the rotary shaft. One plate among the four plates is provided with passage port 41a, which is a through hole for passing the effective component. Guide plate 41 is arranged at the entrance of path 86a that connects outlet 86 and case 81, and at the entrance of path 87a that connects outlet 87 and case 81. In other words, guide plate 41 is arranged between paths 86a, 87a and case 81. Guide plate driving unit 42 is an actuator such as a motor, and rotationally moves guide plate 41 to cause the position of passage port 41a of guide plate 41 to change.

Direction switcher 40 displaces the position of passage port 41a of guide plate 41 based on a drive command from controller 50 to switch directions of the flow of the effective component. For example, direction switcher 40 closes both path 86a and path 87a to fill the inside of table storage 80 with the effective component. Furthermore, direction switcher 40 opens path 86a and closes path 87a to discharge the effective component in table storage 80 from outlet 86. Furthermore, direction switcher 40 opens path 87a and closes path 86a to discharge the effective component in table storage 80 from outlet 87.

First detector 31 is a sensor for detecting whether or not table 90 is stored in table storage 80. For example, first detector 31 is a proximity sensor that detects the lower portion of table 90, and is provided on the inner side surface of case 81. Instead of detecting table 90, first detector 31 may detect the lower end of a movable part of sliding mechanism 83 or the lower end of rotating mechanism 84. First detector 31 may be a normally open contact or may be a normally close contact. A detected signal detected by first detector 31 is transmitted to controller 50.

Second detector 32 is a sensor for detecting an object (for example, human hand) approaching armrest 4. Second detector 32 is, for example, an infrared sensor and the like, and detects whether or not an object (for example, human hand) is placed on armrest 4. While second detector 32 is provided on the top surface of armrest 4, it is considered that when an object (for example, human hand) is placed on armrest 4, the object (for example, human hand) is located near outlet 87 as well. Not limited to the top surface of armrest 4, second detector 32 may be provided near outlet 87. Second detector 32 may be a normally open contact, or may be a normally close contact. A detected signal detected by second detector 32 is transmitted to controller 50.

Controller 50 is a processor that controls operation of effective component generation device 1. Based on signals output from actuation switch 60, first detector 31, and second detector 32, controller 50 controls activation of effective component generator 10, fan 20, and direction switcher 40.

Controller 50 is provided with memory 55, and a program for activating effective component generation device 1 is stored in memory 55. Furthermore, in memory 55, information about modes such as table mode m1 in which the effective component is generated toward inside of table storage 80, cabin mode m2 in which the effective component is caused to flow inside the cabin, and object mode m3 in which when an object approaching armrest 4 is detected, the effective component is caused to flow toward the object is saved.

Table mode m1 is a mode for controlling orientation of direction switcher 40 when table 90 is stored in table storage 80 to cause the effective component to flow into table storage 80. Cabin mode m2 is a mode for controlling orientation of direction switcher 40 when table 90 is pulled out of table storage 80 to cause the effective component to flow inside the cabin. Object mode m3 is a mode for controlling orientation of direction switcher 40 when an object (for example, human hand) is close to armrest 4 to cause the effective component to flow to the object. Based on any mode of table mode m1, cabin mode m2, and object mode m3, controller 50 switches amounts of the flow of the effective component and directions of the flow of the effective component.

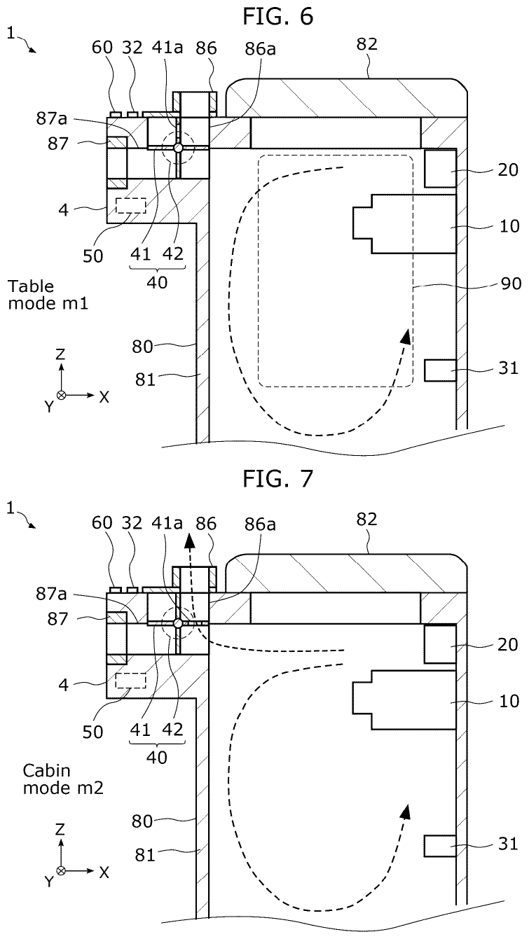

FIG. 6 is a diagram illustrating the flow of the effective component when table 90 is stored in table storage 80. FIG. 6 is a diagram illustrating a state in which effective component generation device 1 is in table mode m1.

When it is determined that table 90 is stored in table storage 80 based on the detected signal output from first detector 31, controller 50 enables table mode m1. That is, controller 50 controls effective component generator 10, fan 20, and direction switcher 40 to cause the effective component to flow into table storage 80 (see the dashed arrow). In this case, controller 50 causes effective component generator 10 to generate the effective component, sets the air volume of fan 20 to a first level, which is the smallest level, and closes both paths 86a and 87a by using guide plate 41 to circulate the effective component in table storage 80. According to the control operation, the effective component is sprayed onto table 90 in table storage 80, and table 90 is made hygienic.

FIG. 7 is a diagram illustrating the flow of the effective component when table 90 is not stored in table storage 80. FIG. 7 is a diagram illustrating a state in which effective component generation device 1 is in cabin mode m2.

When it is determined that table 90 is not stored in table storage 80 based on the detected signal output from first detector 31, controller 50 enables cabin mode m2. That is, controller 50 controls effective component generator 10, fan 20, and direction switcher 40 to cause the effective component to flow inside the cabin (see the dashed arrow). In this case, controller 50 causes effective component generator 10 to generate the effective component, sets the air volume of fan 20 to a second level, at which the air volume is larger than that at the first level, and opens path 86a and closes path 87a by using guide plate 41 to discharge the effective component inside the cabin through outlet 86. According to the control operation, the effective component is sprayed onto air molecules in the cabin, and the inside of the cabin is made hygienic. Here, when path 86a is opened and path 87a is closed in cabin mode m2, part of the effective component flows in table storage 80 as well.

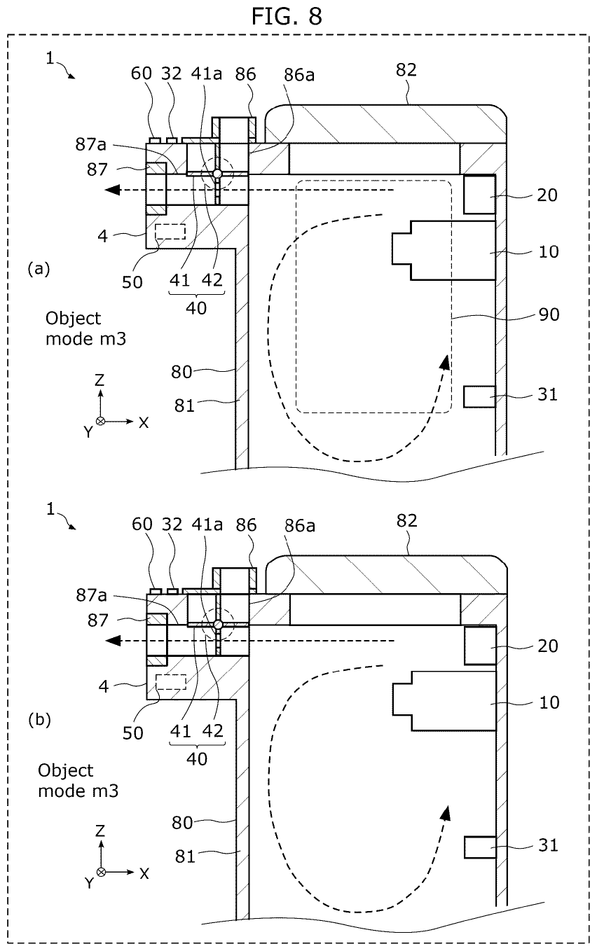

FIG. 8 is a diagram illustrating the flow of the effective component when an object (for example, human hand) is close to armrest 4. FIG. 8 is a diagram illustrating a state in which effective component generation device 1 is in object mode m3. Object mode m3 is a mode that is to be enabled in preference to table mode m1 and cabin mode m2.

In (a) of FIG. 8, there is illustrated the flow of the effective component when table 90 is stored in table storage 80 and an object (for example, human hand) is placed on armrest 4. In (b) of FIG. 8, there is illustrated the flow of the effective component when table 90 is not stored in table storage 80 and an object (for example, human hand) is placed on armrest 4. Both (a) and (b) of FIG. 8 are similar in that an object (for example, human hand) is placed on armrest 4.

When it is determined that an object (for example, human hand) is close to armrest 4 based on the detected signal output from second detector 32, controller 50 enables object mode m3. That is, controller 50 controls effective component generator 10, fan 20, and direction switcher 40 to cause the effective component to flow toward the object (for example, human hand) (see the dashed arrow). In this case, controller 50 causes effective component generator 10 to generate the effective component, sets the air volume of fan 20 to a third level, at which the air volume is larger than that at the second level, and opens path 87a and closes path 86a by using guide plate 41 to discharge the effective component to the object (for example, human hand) through outlet 87.

After second detector 32 detects an object (for example, human hand), controller 50 enables object mode m3 for first time period t1. For example, first time period t1 is between 5 and 15 seconds. According to the control operation, the effective component is sprayed onto the object (for example, human hand). here, when path 87a is opened and path 86a is closed in object mode m3, part of the effective component flows in table storage 80 as well.

After first time period t1, controller 50 returns object mode m3 to the previous mode. Specifically, when table mode m1 was engaged previous to object mode m3, controller 50 changes object mode m3 to table mode m1 after first time period t1. Similarly, when cabin mode m2 was engaged previous to object mode m3, controller 50 changes object mode m3 to cabin mode m2 after first time period t1.

Auxiliary power supply 71 is a power supply for actuating effective component generation device 1 upon the electric system of vehicle 2 being turned off.

For example, controller 50 actuates effective component generation device 1 to generate the effective component for second time period t2 from turning-off of the ignition of vehicle 2. Second time period t2 is longer than first time period t1 and is, for example, between 5 and 15 minutes. In this case, effective component generation device 1 is actuated based on the electric power supplied from auxiliary power supply 71. On condition that the electric power can be supplied from vehicle main body, effective component generation device 1 may be actuated with the electric power supplied from the vehicle main body even when the electric system of vehicle 2 is turned off.

As described above, effective component generation device 1 of the embodiment includes effective component generator 10 that generates an effective component and controller 50 that controls effective component generator 10, and effective component generator 10 generates the effective component in table storage 80 provided to armrest 4 in vehicle 2.

According to the configuration, for example, when table 90 is stored in table storage 80, chances of the table coming into contact with the effective component can be increased. In this way, table 90 can be made hygienic by using the effective component.

### [Operation of Effective Component Generation Device]

Operation of effective component generation device 1 according to the embodiment will be described.

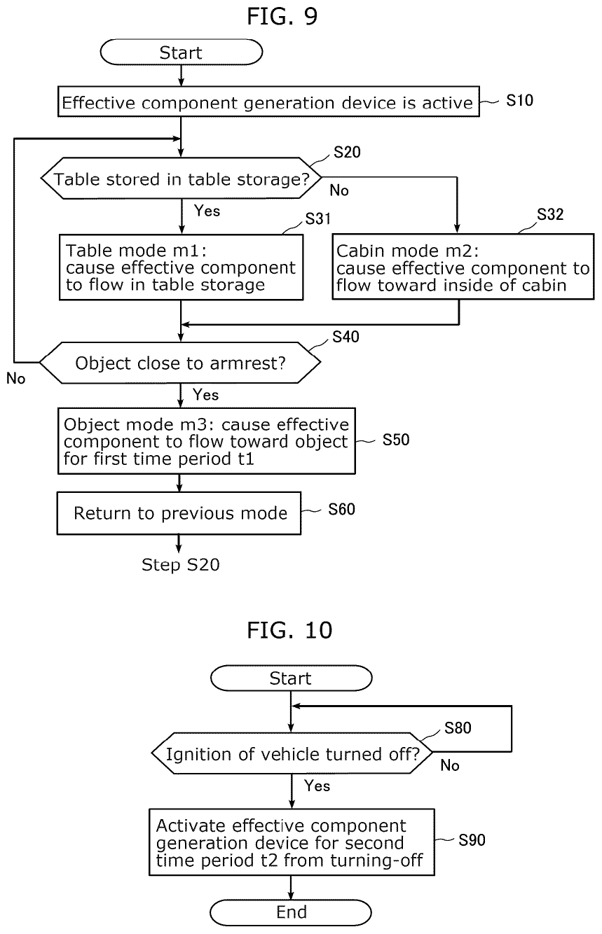

FIG. 9 is a flowchart illustrating operation of effective component generation device 1.

First, actuation switch 60 is turned on to bring effective component generation device 1 into an actuated state (step S10). Here, when actuation switch 60 is kept off, effective component generation device 1 is not brought into the actuated state.

In a state in which effective component generation device 1 is actuated, controller 50 determines whether or not table 90 is stored in table storage 80 (step S20). For example, controller 50 determines that table 90 is stored when first detector 31 detects table 90, and determines that table 90 is not stored when first detector 31 does not detect table 90.

When it is determined that table 90 is stored in table storage 80 (Yes at S20), controller 50 activates effective component generation device 1 in table mode m1 (step S31; see FIG. 6). For example, controller 50 causes effective component generator 10 to generate the effective component, sets the air volume of fan 20 to the first level, and closes both paths 86a and 87a by using guide plate 41 of direction switcher 40 to circulate the effective component in table storage 80.

According to step S31, the effective component is sprayed onto table 90 in table storage 80, and table 90 is made hygienic. Controller 50 saves history information in memory 55 to the effect that table mode m1 is enabled in effective component generation device 1.

Next, controller 50 determines whether or not an object (for example, human hand) is close to armrest 4 (step S40). For example, controller 50 determines that an object (for example, human hand) is close to armrest 4 when second detector 32 detects the object (for example, human hand), and determines that no object (for example, human hand) is close to armrest 4 when second detector 32 does not detect any object (for example, human hand).

When it is determined that no object (for example, human hand) is close to armrest 4 (No at S40), controller 50 returns to step S20, and continues to control operation of effective component generation device 1.

When it is determined that an object (for example, human hand) is close to armrest 4 (Yes at step S40), controller 50 activates effective component generation device 1 in object mode m3 (step S50; see (a) of FIG. 8). For example, controller 50 causes effective component generator 10 to generate the effective component, sets the air volume of fan 20 to the third level, and opens path 87a and closes path 86a by using guide plate 41 of direction switcher 40 to discharge the effective component to the object (for example, human hand) through outlet 87. Controller 50 controls direction switcher 40 to cause the effective component to flow toward the object (for example, human hand) for first time period t1 during which object mode m3 is enabled. According to step S50, the effective component is sprayed onto the object (for example, human hand), and the object (for example, human hand) is made hygienic. Controller 50 saves history information in memory 55 to the effect that object mode m3 is enabled in effective component generation device 1.

After first time period t1, controller 50 returns object mode m3 to the previous mode (step S60). In this case, since the previous mode is table mode m1, controller 50 changes object mode m3 to table mode m1. Then, controller 50 returns to step S20, and continues to control operation of effective component generation device 1.

On the other hand, in step S20, when it is determined that table 90 is not stored in table storage 80 (No at S20), controller 50 activates effective component generation device 1 in cabin mode m2 (step S32; see FIG. 7). For example, controller 50 causes effective component generator 10 to generate the effective component, sets the air volume of fan 20 to the second level, and opens path 86a and closes path 87a by using guide plate 41 of direction switcher 40 to discharge the effective component into the cabin through outlet 86. According to step S32, the effective component is sprayed onto air molecules in the cabin, and the inside of the cabin is made hygienic. Controller 50 saves history information in memory 55 to the effect that cabin mode m2 is enabled in effective component generation device 1.

Next, controller 50 determines whether or not an object (for example, human hand) is close to armrest 4 (step S40). When it is determined that no object (for example, human hand) is close to armrest 4 (No at S40), controller 50 returns to step S20, and continues to control operation of effective component generation device 1.

When it is determined that an object (for example, human hand) is close to armrest 4 (Yes at S40), controller 50 activates effective component generation device 1 in object mode m3 (step S50; see (b) of FIG. 8). Controller 50 controls direction switcher 40 to cause the effective component to flow toward the object (for example, human hand) for first time period t1 during which object mode m3 is enabled. According to step S50, the effective component is sprayed to the object (for example, human hand), and the object (for example, human hand) is made hygienic. Controller 50 saves history information in memory 55 to the effect that object mode m3 is enabled in effective component generation device 1.

After first time period t1, controller 50 returns object mode m3 to the previous mode (step S60). In this case, since the previous mode is cabin mode m2, controller 50 changes object mode m3 to cabin mode m2. Then, controller 50 returns to step S20, and continues to control operation of effective component generation device 1.

According to operation of effective component generation device 1 as illustrated in steps S10 to S60, chances of a subject such as table 90 coming into contact with the effective component can be increased.

### [Another Example of Operation of Effective Component Generation Device]

Next, another example of operation of effective component generation device 1 will be described. In this example, operation of effective component generation device 1 when the ignition of vehicle 2 is turned off will be described.

FIG. 10 is a flowchart illustrating another example of operation of effective component generation device 1.

First, controller 50 determines whether or not the ignition of vehicle 2 is turned off (step S80). When it is determined that the ignition is not turned off (No at step S80), controller 50 returns to step S80, and continues to control operation of effective component generation device 1. Here, whether or not the ignition of vehicle 2 is turned off is determined based on a signal that is transmitted from vehicle 2 and is indicative of on or off of the ignition.

When it is determined that the ignition is turned off (Yes at step S80), for second time period t2 from turning-off of the ignition, controller 50 activates effective component generation device 1 to generate the effective component (step S90). For example, controller 50 activates effective component generation device 1 in table mode m1. Here, controller 50 may activate effective component generation device 1 in the latest mode in history information about modes saved in memory 55.

For example, when the mode at the time of turning-off of the ignition is cabin mode m2, controller 50 may activate effective component generation device 1 in cabin mode m2 for second time period t2.

After second time period t2, controller 50 deactivates effective component generation device 1.

According to the operation of effective component generation device 1 indicated in steps S80 and 90, chances of a subject such as table 90 in vehicle 2 coming into contact with the effective component can be increased even after the ignition is turned off.

### Other Embodiments

Although the effective component generation device according to one or more aspects of the present disclosure has been described based on the above embodiment, the present disclosure is not limited to this embodiment. Those skilled in the art will readily appreciate that embodiments arrived at by making various modifications to the above embodiment without materially departing from the scope of the present disclosure may be included within one or more aspects of the present disclosure.

In the embodiment, an example has been illustrated in which effective component generator 10 is caused to generate the effective component when table 90 is stored in table storage 80, but it is not a limitation. For example, when first detector 31 detects that table 90 is not stored in table storage 80, controller 50 may cause effective component generator 10 to generate the effective component, and close both paths 86a and 87a by means of guide plate 41 to fill the inside of table storage 80 with the effective component. According to this, when a transition is made from a state in which table 90 is not stored in table storage 80 to a state in which table 90 is stored in table storage 80, chances of table 90 coming into contact with the effective component in a short time can be increased.

In FIG. 3 of the embodiment, although an example has been illustrated in which table 90 is put in and taken out via sliding mechanism 83 and rotating mechanism 84, sliding mechanism 83 and rotating mechanism 84 are not essential. For example, there may be provided a guide rail or a groove extending in the vertical direction in the inner side surface of case 81, and table 90 may be put in and taken out along the guide rail or the groove.

In the embodiment, an example has been illustrated in which direction switcher 40 is formed from four guide plates 41 and guide plate driving unit 42, but it is not a limitation. For example, direction switcher 40 may be formed from two opening and closing plates for opening and closing each of two paths 86a, 87a, and two linear drives that linearly move each of the two opening and closing plates. Controller 50 may perform control by using the two opening and closing plates to block two paths 86a, 87a such that the effective component is caused to flow in table storage 80. Controller 50 may perform control by using the opening and closing plate provided in path 87a to open path 87a such that the effective component is caused to flow toward the object. Controller 50 may perform control by using the opening and closing plate provided in path 86a to open path 86a such that the effective component is caused to flow in the cabin of vehicle 2.

For example, in the above-described embodiment, each of the elements included in effective component generation device 1 may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a non-transitory recording medium such as a hard disk or semiconductor memory.

Furthermore, the processing units of effective component generation device 1 may be implemented to a single processor together with an ECU and the like.

It should be noted that the following is also included in the present disclosure.
(1) It should also be noted that at least one of the above-described devices is a computer system including a microprocessor, a Read Only Memory (ROM), a Random Access Memory (RAM), a hard disk unit, a display unit, a keyboard, a mouse, and the like. The RAM or the hard disk unit holds a computer program. The microprocessor operates according to the computer program, thereby causing the constituent elements to execute their functions. Here, the computer program includes combinations of instruction codes for issuing instructions to the computer to execute predetermined functions.
(2) It should also be noted that a part or all of elements in at least one of the above-described devices may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. A computer program is stored in the RAM. The system LSI circuit achieves its function as a result of the microprocessor operating according to the computer program.
(3) It should also be noted that a part or all of the constituent elements included in at least one of the above-described devices may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.
(4) It should also be noted that the present disclosure may be the above-described method. The present disclosure may be a computer program causing a computer to execute the method, or digital signals indicating the computer program.

It should also be noted that the present disclosure may be a computer program or a non-transitory computer-readable recording medium on which digital signals are recorded. Examples of the non-transitory computer-readable recording medium are a flexible disk, a hard disk, a Compact Disc-Read Only Memory (CD-ROM), a Digital Versatile Disc (DVD), a DVD-ROM, a DVD-RAM, a BD (Blu-ray (registered trademark) Disc), and a semiconductor memory. The present disclosure may be the digital signals recorded on such a recording medium.

It should also be noted that, as the present disclosure, the computer program or the digital signals may be transmitted via an electric communication line, a wired or wireless communication line, a network represented by the Internet, data broadcasting, and the like.

It is also possible that the program or the digital signals may be recorded onto the recording medium to be transferred, or may be transmitted via a network or the like, so that the program or the digital signals can be executed by a different independent computer system.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2021-194691 filed on Nov. 30, 2021, and PCT International Application No. PCT/JP2022/039438 filed on Oct. 24, 2022.

### INDUSTRIAL APPLICABILITY

The present disclosure is useful as an effective component generation device for vehicle.

1. An effective component generation device comprising:
an effective component generator that generates an effective component; and
a controller that controls the effective component generator, wherein
the effective component generator generates the effective component toward inside of a table storage provided to an armrest in a vehicle,
the table storage is configured to store a table to be touched with a human hand,
the effective component generator is provided within the table storage,
the effective component generation device further comprises a fan driven and controlled by the controller,
the controller drives the fan when the controller causes the effective component generator to generate the effective component,
the effective component generation device further comprises a direction switcher that selectively changes a direction in which the effective component flows,
the controller controls the direction switcher to control the direction in which the effective component flows, and
when the table is stored in the table storage, the controller controls the direction switcher to cause the effective component to flow into the table storage.

2. The effective component generation device according to claim 1, further comprising:
a first detector that detects whether or not the table is stored in the table storage, wherein
the controller controls the effective component generator based on the detection performed by the first detector.

3. The effective component generation device according to claim 2, wherein
when the first detector detects that the table is stored in the table storage, the controller causes the effective component generator to generate the effective component.

4. The effective component generation device according to claim 1, further comprising:
a second detector that detects an object approaching the armrest, wherein
when the second detector detects the object, the controller controls the direction switcher to cause the effective component to flow toward the object for a first time period.

5. The effective component generation device according to claim 4, wherein
the controller drives the fan to cause an air volume of the fan to be greater when the effective component is made to flow toward the object than when the effective component is made to flow into the table storage.

6. The effective component generation device according to claim 4, wherein
after the first time period, the controller controls the direction switcher to prevent the effective component from flowing toward the object and cause the effective component to flow into the table storage.

7. An effective component generation device comprising:
an effective component generator that generates an effective component; and
a controller that controls the effective component generator, wherein
the effective component generator generates the effective component toward inside of a table storage provided to an armrest in a vehicle,
the table storage is configured to store a table to be touched with a human hand,
the effective component generator is provided within the table storage,
the effective component generation device further comprises
a fan driven and controlled by the controller,
the controller drives the fan when the controller causes the effective component generator to generate the effective component,
the effective component generation device further comprises a direction switcher that selectively changes a direction in which the effective component flows,
the controller controls the direction switcher to control the direction in which the effective component flows, and
when the table is not stored in the table storage, the controller controls the direction switcher to cause the effective component to flow inside a cabin of the vehicle.

8. The effective component generation device according to claim 7, further comprising:
a second detector that detects an object approaching the armrest, wherein
when the second detector detects the object, the controller controls the direction switcher to cause the effective component to flow toward the object for a first time period.

9. The effective component generation device according to claim 8, wherein
the controller drives the fan to cause an air volume of the fan to be greater when the effective component is made to flow toward the object than when the effective component is made to flow inside a cabin of the vehicle.

10. The effective component generation device according to claim 8, wherein
after the first time period, the controller controls the direction switcher to prevent the effective component from flowing toward the object and cause the effective component to flow inside a cabin of the vehicle.

11. An effective component generation device comprising:
an effective component generator that generates an effective component; and
a controller that controls the effective component generator, wherein
the effective component generator generates the effective component toward inside of a table storage provided to an armrest in a vehicle,
the table storage is configured to store a table to be touched with a human hand,
the effective component generator is provided within the table storage,
the effective component generation device further comprises a first detector that detects whether or not the table is stored in the table storage,
the controller controls the effective component generator based on the detection performed by the first detector, and
when the first detector detects that the table is not stored in the table storage, the controller causes the effective component generator to generate the effective component to fill the inside of the table storage with the effective component.

12. The effective component generation device according to claim 1, wherein
the controller causes the effective component generator to generate the effective component for a second time period from turning-off of an ignition of the vehicle.

13. The effective component generation device according to claim 1, wherein
the table to be stored in the table storage includes an input interface for operating a device provided to the vehicle.

14. The effective component generation device according to claim 7, wherein
the controller causes the effective component generator to generate the effective component for a second time period from turning-off of an ignition of the vehicle.

15. The effective component generation device according to claim 7, wherein
the table to be stored in the table storage includes an input interface for operating a device provided to the vehicle.

16. The effective component generation device according to claim 11, wherein
the controller causes the effective component generator to generate the effective component for a second time period from turning-off of an ignition of the vehicle.

17. The effective component generation device according to claim 11, wherein
the table to be stored in the table storage includes an input interface for operating a device provided to the vehicle.
